(19) United States
(12) Patent Application Publication
(10) Pub. No.: US 2026/0150991 A1
(43) Pub. Date: Jun. 4, 2026

(54) SYSTEM AND METHOD FOR GUIDING AND TEACHING PRAYER

(71) Applicant: Linda SHAABAN, Hoffman Estates, IL (US)

(72) Inventor: Linda SHAABAN, Hoffman Estates, IL (US)

(21) Appl. No.: 19/399,461

(22) Filed: Nov. 24, 2025

Related U.S. Application Data
(60) Provisional application No. 63/725,285, filed on Nov. 26, 2024.

(51) Int. Cl. A47G 33/00; G09B 5/02

(52) U.S. Cl. CPC A47G 33/008; G09B 5/02

(57) ABSTRACT

The system enables users to more efficiently and easily conduct, guide, and teach prayer rituals. The method includes using a system of separate and reversible markers. The system has two sides, a side A and a side B. Either side can be reset by marking and confirming that all markers shown on one side of the system are in an unmarked position. The markers can have both unmarked and marked positions. When a marker is depressed into the marked position on Side A, the corresponding marker on Side B is pushed into the unmarked position. The user can conduct a prayer ritual by reciting a prayer and marking a marker into the marked position and continuing to use the system until the prayer goal is met.

### RELATED APPLICATION

This application claims the benefit of U.S. Provisional Patent Application No. 63/725,285 filed Nov. 26, 2024 and entitled “System and Method for Guiding and Teaching Prayer,” the entire contents of which is incorporated herein by reference and relied upon.

### BACKGROUND

### Technical Field

The present disclosure generally relates to systems and methods enabling guiding and teaching prayers.

### Background Information

In certain forms of religious worship, users repeatedly recite phrases or prayers for the purpose of remembering God. These prayer recitations or rituals can be matched to numbers that have significance in the religion. Other times, the number of prayer recitations or rituals are not linked or have no significance in the religion.

### SUMMARY

The present disclosure enables a user to conduct a prayer ritual, to guide a prayer ritual, or teach reciting of prayer rituals.

A first aspect of the present disclosure is to provide a system for enabling conducting a prayer ritual, to guide a prayer ritual, or teach reciting of prayer rituals. The method includes a user resetting a system of separate markers. The markers are reversible and are placed within the system visible on both sides of the system. The system has at least two sides, a Side A and a Side B. Either side can be reset by moving or acting upon markers and confirming that all markers shown on one side of the system are in an unmarked position. The markers can have both unmarked and marked positions. When a marker is marked in the marked position on Side A, the corresponding marker on Side B reorients in the unmarked position. The user can conduct a prayer ritual by reciting a prayer and marking a marker into the marked position. Marking the marker into the marked position allows the user to keep track of the prayers recited. Marking the marker into the marked position also resets the markers on the other side of the system as unmarked.

A second aspect of the present disclosure is to provide a method of guiding a prayer ritual. The method includes marking one or more markers on a system to designate prayers recited. The method also includes reversing or flipping the system to access the markers on the other side. The method also includes continuing the marking and flipping of the system until the proper guidance of the ritual is finished.

In another aspect of the invention, the system can include ninety-nine markers.

In another aspect of the invention, the system can include thirty-three markers.

In another aspect of the invention, the system can include eleven markers.

In another aspect of the invention, the system can include nine markers.

In another aspect of the invention, the system can include a customized plurality of markers.

In another aspect of the invention, the system can include electronic elements. The electronic elements can include one or more of the following: counters, marker controllers, markers, reinforcement outputs, lights, sounds, motion devices, reinforcement device controllers, and electronic toy elements such as transmitters and receivers for different wireless components of devices. The system can include electronic elements that allow for only one physical side showing markers in the marked or unmarked state. Side A and Side B can appear on the same physical side when the system can reset and show the markers electronically. In an electronic embodiment, the markers can be lights that indicate marked or unmarked status by being on or off. In an electronic embodiment, a counter for how many times the system has been reoriented.

In another aspect of the system, Toy Side B of system is on the other side of Toy Side A and is a mirror image. In one aspect of a system consisting of physically manipulated markers, the markers appear as marked on Toy Side A and unmarked on Toy Side B.

In another aspect of the invention, the system can include electronic controller elements. The controller elements can include one or more of the following: device controllers, sensors, actuators, motors, and other devices to manage aspects of the system. The controller elements can also include software or firmware to assist in controlling the system. The controller elements can include artificial intelligence components. Such artificial intelligence can assist with calculating information related to the training and guidance and can provide information including customized performance and reinforcement information to update the training and guidance provided by the system. In these types of embodiments reorienting the system can be equivalent to resetting the markers.

In another aspect of the invention, the system can include electronic controller elements. The controller elements can include one or more of the following: device controllers, sensors, actuators, motors, and other devices to manage aspects of the system such as marking and unmarking markers. The controller elements can also include software or firmware to assist in controlling the system. The controller elements can include artificial intelligence components. Such artificial intelligence can assist with calculating information related to the training and guidance and can provide information including customized performance and reinforcement information to update the training, future reinforcement, and guidance provided by the system. In these types of embodiments reorienting the system can be equivalent to resetting the markers.

Other objects, features, aspects and advantages of the systems and methods disclosed herein will become apparent to those skilled in the art from the following detailed description, which, taken in conjunction with the annexed drawings, discloses exemplary embodiments of the disclosed systems and methods.

### BRIEF DESCRIPTION OF THE DRAWINGS

Referring now to the attached drawings which form a part of this original disclosure:

FIG. 1 illustrates an example embodiment of a system for enabling conducting a prayer ritual, to guide a prayer ritual, or teach reciting of prayer rituals;

FIG. 2 illustrates an example embodiment of a plurality of markers in the system of FIG. 1;

FIG. 3 illustrates an example embodiment of a method for enabling conducting a prayer ritual, to guide a prayer ritual, or teach reciting of prayer rituals using the system of FIG. 1;

FIG. 4 illustrates a block diagram of an electronic system embodiment for enabling conducting a prayer ritual, to guide a prayer ritual, or teach reciting of prayer rituals; and

FIG. 5 illustrates an example embodiment of a method for enabling conducting a prayer ritual, to guide a prayer ritual, or teach reciting of prayer rituals using the system of FIG. 1 including electronic controller and artificial intelligence elements.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

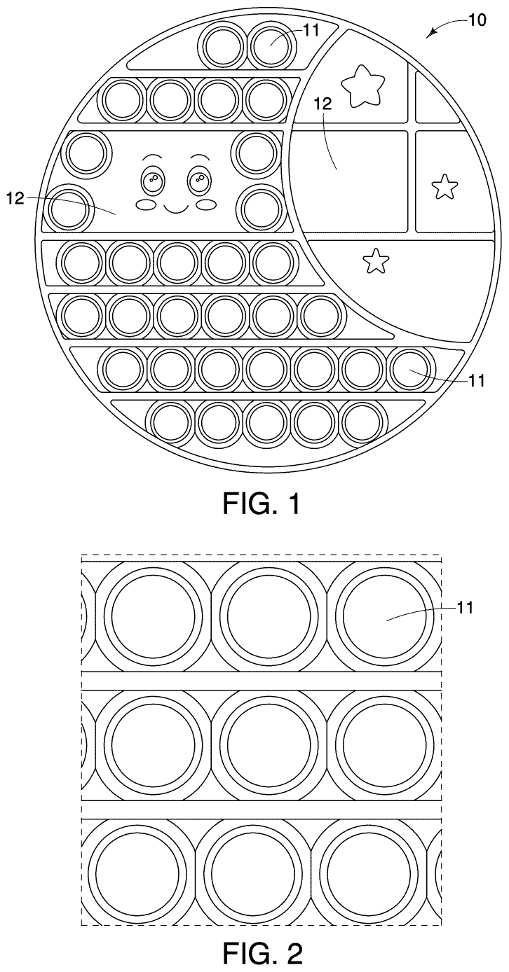

FIG. 1 illustrates an example embodiment of a system 10 for enabling conducting a prayer ritual, to guide a prayer ritual, or teach reciting of prayer rituals. The system 10 includes a plurality of reversible markers 11 that include two sides. If one of the sides of the markers 11 is marked, the other side is unmarked and these positions can be reversed. The plurality of reversible markers 11 can be positioned in any pattern or randomly on one side of the system 10. When the system 10 is turned over, the pattern will be reversed and the markers 11 shown on that side of the system 10 will be in the opposite or reverse position of the markers 11 on the side previously marked by the user. There can be additional educational information 12 provided on the system 10 so that the system 10 can be further self-contained.

FIG. 2 illustrates an example embodiment of a plurality of markers 11 in the system 10 of FIG. 1. In an embodiment, each of the markers 11 is configured to be manipulated into a marked or unmarked position. The markers 11 are configured to provide a tactile reaction for the user when the markers 11 are marked. The markers 11 can also be configured to provide an auditory reaction provided when the markers 11 are marked. The markers 11 can also be configured to provide a visual response when the markers 11 are marked such as a light turning on or off.

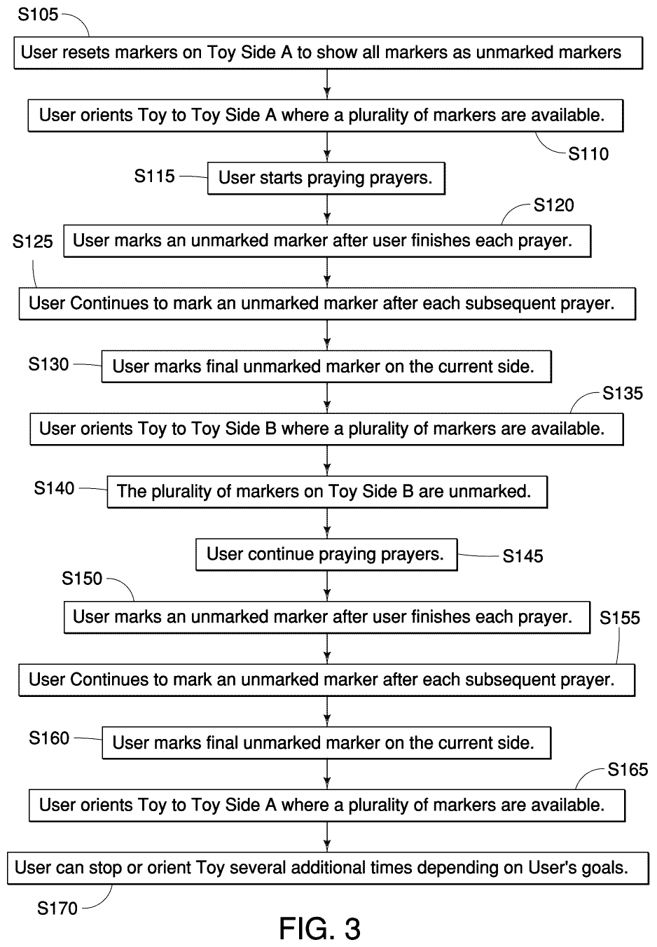

FIG. 3 illustrates an example embodiment of the method of using the system 10 in FIG. 1 to enable conducting a prayer ritual, to guide a prayer ritual, or teach reciting of prayer rituals. The method comprises resetting S105 the system 10 to show all markers 11 in an uniform marked position. The method further comprises orienting S110 the system 10 to a first toy side A 13 where all markers 11 are in the raised or unmarked position. The system 10 contains a plurality of markers 11 available for the user. The method further comprises reciting prayers S115. The method further comprises marking S120 a marker 11 after a prayer is finished. The method further comprises continuing to mark S125 the unmarked markers 11 until all the markers 11 on the first toy side A 13 are marked. The method further comprises finally marking S130 the final unmarked marker 11 on the first toy side A 13. The method further comprises reorienting S135 the system 10 to a second toy side B 14. The method further comprises the second toy side B 14 of the system 10 showing S140 markers 11 that are now in an unmarked position. The method further comprises the user continuing prayers S145 using the system 10 until the goals of the user are met. The method further comprises continuing marking S150 a marker 11 after a prayer is finished. The method further comprises continuing to mark S155 the unmarked markers 11 on the second toy side B 14. The method further comprises continuing finally marking S160 the final unmarked marker 11 on the second toy side B 14. The method further comprises reorienting S165 the system 10 to the first toy side A 13. The toy system 10 can be manipulated into a reset position when all markers 11 are in an uniform marked position on either the first toy side A 13 or the second toy side B 14.

The toy system 10 can include markers 11 that of different sizes, shapes, colors, and textures. The markers 11 can designate different actions such as prayers taken by the user.

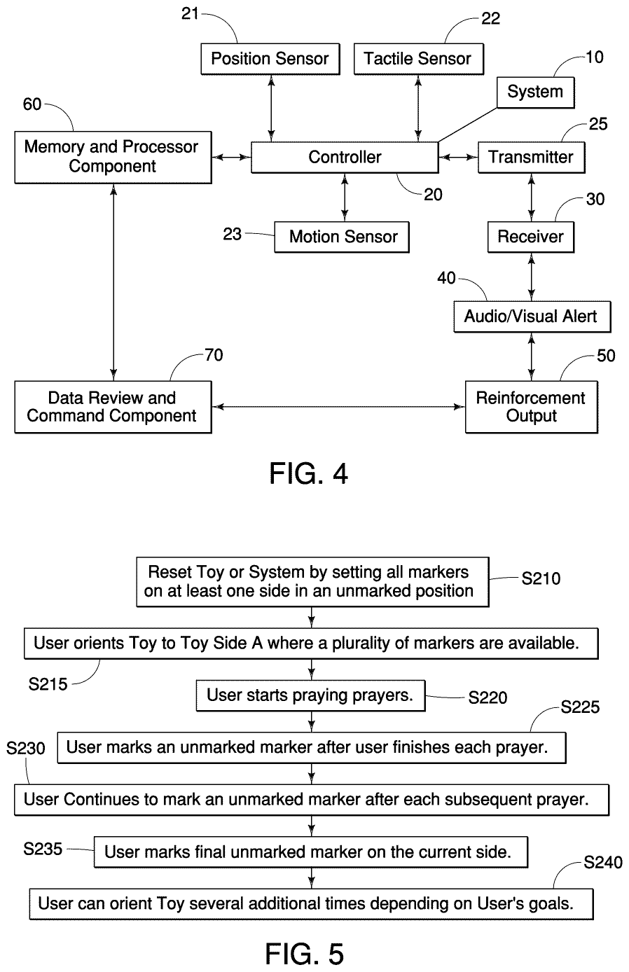

FIG. 4 illustrates a block diagram of one electronic system embodiment of the invention for enabling conducting a prayer ritual, guiding a prayer ritual, and teaching of prayer rituals. The block diagram of the electronic system embodiment of system 10 comprises a controller 20 communicating with a memory and processor component 60, a position sensor 21, a tactile sensor 22, a motion sensor 23, a transmitter 25, a receiver 30, an alert component 40, a reinforcement component 50, and a data review and command component 70.

In one embodiment of an invention, the controller 20 can include a timer.

In one embodiment of an invention, the position sensor 21 can determine the marked or unmarked position of a marker 11 by the position of the marker 11 in relation to the system 10.

In another embodiment of an invention, the tactile sensor 22 can determine the marked or unmarked position of a marker 11 by recording the number of touches by the user of the marker 11 in relation to the system 10.

In another embodiment of an invention, the motion sensor 23 can determine the marked or unmarked position of a marker 11 by recording the number of marking movements initiated by the user of the marker 11 in relation to the system 10.

In an embodiment of the invention, the system 10 includes a controller 20 communicating information and sending commands using data from the position sensor 21, tactile sensor 22, and motion sensor 23, to the memory and processor component 60. The data review and command component 70 communicates with the memory and processor component 60 to analyze historic data and provide commands through the controller 20 to the transmitter 25 to the receiver 30 to the alert component 40 to provide an alert to the user identifying a positive or negative result. The alert component 40 is configured to trigger a reinforcement component 50.

In one embodiment of the invention, the system 10 is configured to provide custom positive reinforcement to the user through the reinforcement component 50 which can be a separate reward container. The controller 20 transmits instructions and information related to historic marked and unmarked data. through the transmitter 25 to the receiver 30 communicating with the reinforcement component 50 to open the reward container.

In one embodiment of the invention, the system 10 is configured to provide custom positive reinforcement to the user through the reinforcement component 50 which can be a audio visual media device. The audio visual device can be in a locked position. The controller 20 transmits instructions through the transmitter 25 to the receiver 30 communicating with the reinforcement component 50 to unlock the audio visual media device. The reinforcement component 50 can unlock the audio visual media device for customized set time increments.

In one embodiment of the invention, the method for enabling conducting a prayer ritual, guiding a prayer ritual, or teaching reciting of prayer rituals using a system 10 communicates historic data to the data review and command component 70.

In one embodiment of the invention, the data review and command component 70 provides commands to the reinforcement component 50 to customize the reinforcement. For example, if the historic data shows incomplete marker 11 data, then the reinforcement component 50 does not unlock an audio visual media device or only unlocks the audio visual media device for a lesser amount of time.

In one embodiment of the invention, the data review and command component 70 provides commands to the reinforcement component 50 to customize the reinforcement. For example, if the timer data shows resetting of marker 11 data that is not within a set time parameter, then the reinforcement component 50 does not unlock an audio visual media device or only unlocks the audio visual media device for a lesser amount of time.

In one embodiment of the invention, the system 10 is configured to provide customized positive reinforcement to the user through the reinforcement component 50 which can be configured to issue physical or virtual tokens. Users can collect and trade tokens for items.

FIG. 5 illustrates an example embodiment of a method for enabling conducting a prayer ritual, guiding a prayer ritual, or teaching reciting of prayer rituals using a system 10 comprising both an electronic controller 20 and artificial intelligence elements including a memory and processor component 60, a data review and command component 70, and a reinforcement component 50 to assist in training the system 10 to respond to the user marking the plurality of markers 11. The method comprises resetting S210 the system 10 to show all markers in an uniform marked position. The method further comprises orienting S215 the system 10 to a first toy side A 13 where all markers 11 are in the unmarked position. The method further comprises reciting prayers S220. The method further comprises marking S225 a marker 11 after a prayer is finished. At The method further comprises continuing to mark S230 the unmarked markers 11 until all the markers 11 on the first toy side A 13 are marked. The method further comprises finally marking S235 the final unmarked marker 11 on the first toy side A 13. The method further comprises reorienting S240 the system 10 to a second toy side B 14. The user can stop at this point or start again at S215.

The systems and methods described herein are advantageous for enabling training. The disclosed systems and methods are particularly advantageous in reducing complexity of conducting, guiding, and teaching prayers as described herein. It should be understood that various changes and modifications to the methods described herein will be apparent to those skilled in the art and can be made without diminishing the intended advantages.

### GENERAL INTERPRETATION OF TERMS

In understanding the scope of the present invention, the term “comprising” and its derivatives, as used herein, are intended to be open ended terms that specify the presence of the stated features, elements, components, groups, and/or steps, but do not exclude the presence of other unstated features, elements, components, groups, integers and/or steps. The foregoing also applies to words having similar meanings such as the terms, “including”, “having” and their derivatives. Also, the terms “part,” “section,” or “element” when used in the singular can have the dual meaning of a single part or a plurality of parts. Accordingly, these terms, as utilized to describe the present invention should be interpreted relative to a connecting device.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components and portions of the system can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A system for guiding a prayer ritual comprising:
a toy with a first toy side, a second toy side, a plurality of reversible markers wherein each marker is capable of being marked by a user by depressing the marker, and an additional information.

2. The system of claim 1 further comprising:
a controller configured to control the reaction of the system to data from a sensor array,
a memory and processor component configured to store and process data,
a transmitter configured to transmit instructions related to an alert,
a received configured to communicate with the transmitter and an alert component, the alert component configured to provide an alert to a user.

3. The system of claim 1 further comprising:
a reinforcement component configured to communicate with a data review and command component to unlock an audio visual media device for a user.

4. The system of claim 3 wherein the sensor array includes a position sensor.

5. The system of claim 3 wherein the sensor array includes a tactile sensor.

6. The system of claim 3 wherein the sensor array includes a motion sensor.

7. The system of claim 3 wherein the data review and component is further configured to include a timer.

8. The system of claim 7 wherein the timer is further configured to communicate with the controller, the memory and processor component, and the reinforcement component to lock an audio visual media device.

9. A method for guiding a prayer ritual, the method comprising the user:
resetting the system to position a plurality of all markers in a uniform position;
orienting the system to a first side wherein the plurality of all markers are in the unmarked position;
reciting prayers;
marking one marker after one prayer is finished;
continuing to mark one unmarked markers after one prayer is finished;
finally marking the final unmarked marker on first side;
stopping any marking of markers on the first side when the plurality of all markers are in the marked position.

10. The method of claim 9, further comprising the user:
reorienting the system to a second side;
confirming the plurality of all markers shown on the second side are in an unmarked position;
continuing prayers and marking one marker after one prayer is finished;
continuing to mark one unmarked marker on the second side after each prayer is finished;
finally marking the final unmarked marker on the second side.

11. The method of claim 10 further comprising;
reorienting the system to the first side;
confirming the plurality of all markers shown on the first side are in an unmarked position;
continuing prayers and marking one marker after one prayer is finished;
continuing to mark one unmarked marker on the first side after each prayer is finished; and
finally marking the final unmarked marker on the first side.

12. The method of claim 11 further comprising additional reorienting and marking the plurality of markers based on user prayer goals.

13. The method of claim 11 further comprising reviewing a timer.

14. The method of claim 11 further comprising reviewing historic data related to the user marking of markers.

15. The method of claim 11 further comprising alerting the user that all markers on the first side are marked.

16. The method of claim 15 further comprising reinforcing the user by opening a reward container.

17. The method of claim 15 further comprising reinforcing the user by unlocking a locked audio visual media device.

18. The method of claim 15 further comprising reinforcing the user by locking a an unlocked audio visual media device.

19. The method of claim 15 further comprising reinforcing the user by providing physical tokens.

20. The method of claim 15 further comprising reinforcing the user by providing virtual tokens.
